(19) United States
(12) Patent Application Publication
(10) Pub. No.: US 2023/0182516 A1
(43) Pub. Date: Jun. 15, 2023

(54) TRAILER HITCH FOR MOTOR VEHICLES

(71) Applicant: ACPS Automotive GmbH, Ingersheim (DE)

(72) Inventor: Pascal Wisirenko, Eberdingen (DE)

(73) Assignee: ACPS Automotive GmbH, Ingersheim (DE)

(21) Appl. No.: 18/064,994

(22) Filed: Dec. 13, 2022

(30) Foreign Application Priority Data
Dec. 15, 2021 (DE) 102021133348.2

(51) Int. Cl. B60D 1/54; B60D 1/06

(52) U.S. Cl. CPC B60D 1/54; B60D 1/06

(57) ABSTRACT

In a trailer hitch for motor vehicles, comprising a bearing unit which carries a ball neck which at a first end is connected to the bearing unit and at a second end carries a hitch ball, and a holding base which supports the bearing unit and which is connectable to a vehicle body, in particular by means of a crossmember mountable on the vehicle body, in order to reduce the mass of the holding base it is proposed that the holding base has a mounting body that has at least two interconnected shaped parts made of flat material, and that the mounting body on the one hand forms a mounting region molded into the shaped parts and on the other hand forms at least one stiffening region arranged outside the mounting region and molded into the shaped parts.

### CROSS-REFERENCE TO RELATED PATENT APPLICATION

The present disclosure relates to the subject matter disclosed in German application number 10 2021 133 348.2 of Dec. 15, 2021, which is incorporated herein by reference in its entirety and for all purposes.

### BACKGROUND OF THE INVENTION

The invention relates to a trailer hitch for motor vehicles, in particular passenger motor vehicles, comprising a bearing unit which carries a ball neck which at a first end is connected to the bearing unit and at a second end carries a hitch ball, and a holding base which supports the bearing unit and which is connectable to a vehicle body, in particular by means of a crossmember mountable on the vehicle body.

Such trailer hitches are known from the prior art; in these trailer hitches there is a need to reduce the mass of the holding base in order to thus ultimately also positively influence the mass of the motor vehicle.

### SUMMARY OF THE INVENTION

This problem is solved in accordance with the invention in a trailer hitch of the kind described at the outset in that the holding base has a mounting body that has at least two interconnected shaped parts made of flat material, and in that the mounting body on the one hand forms a mounting region molded into the shaped parts and on the other hand forms at least one stiffening region arranged outside the mounting region and molded into the shaped parts.

The advantage of this solution can be considered to be that, due to the at least two shaped parts made of flat material, it is possible to form the mounting body in the most stable manner possible and also to reduce its mass to the greatest possible extent.

It is particularly advantageous here if, in the mounting region, at least one of the shaped parts forms at least one support surface for the bearing unit.

In respect of the arrangement of the shaped parts, it has proven to be advantageous if these are arranged on mutually opposed sides of a center plane running transversely to the crossmember.

In particular, it is advantageous in view of the advantageous production of the shaped parts if each of the shaped parts is formed in one piece.

A particularly advantageous solution provides that each of the shaped parts has a contour profile that, on the corresponding side of a center plane of the mounting body, has an extent between outer regions of the mounting body but varies by reshaping of the flat material transversely to the areal extent of said material.

With a contour profile that varies in this way between the outer regions of the mounting body, the necessary rigidity of the shaped parts can advantageously be achieved.

To this end, it has proven to be particularly advantageous if the mounting region is molded in the contour profile of at least one of the shaped parts.

It is also advantageous if the at least one stiffening region is molded into the contour profile of at least one of the shaped parts.

In order to be able to fix the bearing unit optimally to the mounting body, it is preferably provided that an aperture is provided in the mounting region to partially receive the bearing unit and penetrates at least one shaped part, in particular both shaped parts.

In particular, the bearing unit can extend into the aperture or can pass through the aperture.

In respect of the arrangement of the support surface relative to the aperture, it is preferably provided that the support surface is arranged outside the aperture.

Here, the support surface can be provided in the respective shaped part on one side of the aperture or on opposite sides of the aperture.

It is particularly advantageous if the support surface is arranged in a manner running around the aperture.

In principle, the aperture could be formed rotationally symmetrically to a center axis.

In order to be able to use the aperture advantageously also to fix the bearing unit non-rotatably, it is preferably provided that the aperture has a shape deviating from a rotational symmetry with respect to a center axis of the aperture.

In particular, it is provided here that the aperture is configured to receive a portion, in particular a bearing body, of the bearing unit.

The portion of the bearing unit received by the aperture preferably cooperates here with the shape of the aperture deviating from a rotational symmetry with respect to the center axis, so that the cooperation between the aperture and the portion of the bearing unit adapted so as to correspond to the shape of the aperture leads already to a non-rotatable fixing of this portion of the bearing unit relative to the mounting body.

In respect of the support of the bearing unit on the mounting body, different solutions are conceivable.

For example, a point support of the bearing unit is conceivable. A particularly stable connection between the bearing unit and the mounting body is achieved in that the bearing unit abuts with a support element against the support surface.

In one solution it is also provided that the bearing unit is supported at least on one of the shaped parts.

However, it is particularly advantageous if the bearing unit is supported on each of the shaped parts in order to introduce the forces acting from the bearing unit as uniformly as possible into the mounting body so that they act in particular directly on each of the shaped parts.

This can be achieved for example by support of the bearing unit by means of a support surface provided on each of the shaped parts.

Alternatively or additionally another advantageous solution provides that the bearing unit is supported on at least one, in particular on each, of the shaped parts in the region of the aperture and thus the bearing unit is also supported advantageously on the mounting body in respect of tilting moments to be transferred from the bearing unit.

For connection of the bearing unit to the mounting body it is preferably provided that the bearing unit has a bearing body which engages in the aperture.

Here, the bearing body is preferably configured such that it is supported on one side of the mounting body by a support body and on an opposite side of the mounting body by a holding element.

To fix the holding element on the bearing body it is preferably provided that the bearing body has a bearing sleeve which penetrates the opening and which, on a side opposite the support body, has a holding extension, which in particular protrudes beyond the aperture, has a holding receptacle, and to which the holding element is fixable.

It is particularly favorable here if the holding element and the holding receptacle are configured so as to cooperate in such a way that the holding element is movable towards the support element by a relative movement in relation to the holding receptacle.

For example, in this context the holding receptacle could have a contour which varies in the axial direction of the bearing body and with which the holding element cooperates.

A contour of this kind could be a thread, for example, by which the holding element cooperates with an internal thread.

Another possibility provides that the holding receptacle is a groove in which the holding element engages with wedge bodies, wherein the wedge bodies are movable towards the support element with increasing engagement in the groove.

With a holding receptacle of this kind and a holding element configured in accordance with the above definition, it is possible to clamp the mounting body, for example in the mounting regions between the support element and the holding element, and thus to fix the bearing body of the bearing unit on the mounting body, in particular by clamping the latter between the support element and the holding element.

It is also preferably provided that a plurality of fastening openings for connection elements for mounting of the bearing unit, said openings penetrating both shaped parts, are provided in the mounting region, in particular around the aperture and at a spacing therefrom.

No further details have yet been provided in respect of the configuration of the bearing unit.

The bearing unit could produce, for example, a connection for conjoint rotation between the mounting body and the ball neck.

In this case the bearing unit could be configured as an insertion receptacle, into which the ball neck can be inserted releasably.

Another advantageous solution provides that the bearing unit is configured as a pivot bearing unit, on which the ball neck is mounted pivotably about a pivot axis.

Here, in particular a pivoting movement of the ball neck between a working position and a rest position is performed, wherein the ball neck in the working position protrudes against a direction of travel beyond a rear bumper unit of the motor vehicle and in the rest position is arranged between the rear bumper unit of the motor vehicle and the vehicle body and at the same time is not visible from the outside and is positioned in a protected manner.

In particular in the case of a pivotable mounting of the ball neck it is provided that the mounting body and in particular also the center plane of the mounting body extends perpendicularly to the pivot axis.

Such a profile of the mounting body makes it possible in particular to arrange the ball neck as close as possible to the mounting body and thus to pivot the ball neck collision-free in relation to the mounting body between the working position and the rest position.

A further advantageous solution provides that the pivot bearing unit penetrates the aperture and on one side of the aperture supports the ball neck pivotably and on the other side of the aperture has a drive unit for locking the ball neck in the working position and/or the rest position and/or for performing the pivoting movement about the pivot axis.

This solution has the advantage that the mounting body can thus be positioned relative to the pivot bearing unit such that the forces acting on the ball neck and transferred to the pivot bearing unit can be introduced optimally into the mounting body.

No further details have yet been provided in respect of the connection of the shaped parts.

For example, one advantageous solution provides that the shaped parts are fixedly connected to one another in the at least one stiffening region.

A connection of this kind is established for example with a substance-to-substance bond and/or with positive engagement and/or by means of connection elements such as screws or rivets.

In respect of the stiffening of the mounting body it is particularly advantageous if the mounting body has a stiffening region on both sides of the mounting region.

The stiffening regions are in particular particularly effective if they extend as far as the outer regions of the mounting body.

The stiffening regions therefore preferably run along outer regions of the mounting body.

An advantageous stiffening of the mounting body is in particular achievable if the mounting body has, in the corresponding stiffening region relative to the mounting region, a bulge running away from a center plane of the mounting body, formed by at least one of the shaped parts, in particular by both shaped parts, that is to say in the stiffening region the spacing between the shaped parts is greater than in the mounting region in order to thus achieve a stiffer form of the mounting body.

The stiffening regions are of a particularly advantageous form if they have molded-in beads or bent edges of at least one of both shaped parts.

It is advantageously provided that the bulging of the mounting body is formed by beads or folded edges, running away from one another, of at least one of the shaped parts.

It is particularly favorable if at least one shaped part, in particular both shaped parts in the respective stiffening region have, in cross section, at least one, in particular a plurality of stepped embossings of the flat material.

It is expediently provided here, in order to stabilize the mounting region, that at least one of the stepped embossings of the flat material is formed in a manner running around the mounting region.

It is also advantageously provided that at least one of the stepped embossings of the flat material extends in the vicinity of an outer region of the mounting body.

For connection of the shaped parts in the stiffening region, it is advantageous if the shaped parts have connection segments lying against one another in at least one stiffening region.

The connection segments preferably lie on an outer region of the shaped parts and are in particular integrally molded onto the shaped parts in one piece.

For example, the shaped parts are connected to one another in the region of the connection segments by a substance-to-substance bond.

Alternatively or additionally to this, it is provided that the shaped parts are connected to one another in the region of the connection segments by positive engagement.

Alternatively or additionally it is provided that the connection segments are connected to one another by means of screws and/or rivets.

In respect of the configuration of the individual shaped parts it is preferably provided that, to form each stiffening region, the flat material of at least one of the shaped parts runs in the corresponding stiffening region at least in some regions at a greater spacing from the other of the shaped parts than in the mounting region.

For example, this can be realized in that the shaped parts in the stiffening region have at least one reshaping, by means of which the flat material of the shaped parts runs in the stiffening region in some regions at a greater spacing from one another than in the mounting region.

For example, this is realized in that the shaped parts in the at least one stiffening region have reshapings which cause the flat material of at least one of the shaped parts to be increasingly distanced from the flat material of the other of the shaped parts at least in some regions.

For example, a reshaping of this kind of the respective shaped part can be formed as a folded edge or raised edge running away from the other shaped part.

A further advantageous dimensional stabilization of the mounting body can be achieved in that the shaped parts have, on a side opposite the crossmember, at least one connection segment by means of which the shaped parts are fixedly connected to one another.

A further stabilization of the mounting body can be achieved in that this has, on a side lying between stiffening regions, holding flanges for connection to the crossmember of the trailer hitch.

In particular the holding flanges are provided here with receptacles for the crossmember, wherein the receptacles are preferably connected to the crossmember with positive engagement and in particular also additionally with a substance-to-substance bond.

The connection of the mounting body to the crossmember thus provides an additional stabilization thereof.

No further details have yet been provided in respect of the arrangement of the shaped parts relative to one another.

In principle, the shaped parts could abut against one another in the mounting regions.

For example, one advantageous solution provides that the shaped parts in the mounting region are arranged at a spacing from one another, such that there is a spacing between the corresponding regions of the flat material of the shaped parts also in the mounting region.

Since in particular in the mounting region there should be an optimal introduction of force onto the shaped parts it is preferably provided that the shaped parts are held, in the mounting regions, running at a spacing from one another by support elements acting between the shaped parts and in particular are supported relative to one another.

It is preferably provided here that, in the mounting region, the support elements are arranged in a gap between the shaped parts and support the shaped parts relative to one another.

A possibility for forming such support elements is that the support elements are individual bodies which extend from one shaped part to the other.

Another possibility is that the support elements are plate-like elements, for example plate-like insert parts, which are formed from flat material and are arranged one above the other.

A further advantageous solution provides that the support elements are formed as annular bodies running around the aperture.

It is particularly advantageous in this case if the support elements have a recess that is congruent with the aperture.

The above description of solutions according to the invention thus comprises, in particular, the various combinations of features defined by the following consecutively numbered embodiments:

1. A trailer hitch for motor vehicles, comprising a bearing unit (20) which carries a ball neck (10) which at a first end (12) is connected to the bearing unit (20) and at a second end (16) carries a hitch ball (18), and a holding base (30) which supports the bearing unit (20) and which is connectable to a vehicle body (F), in particular by means of a crossmember (34) mountable on the vehicle body (F), wherein the holding base (30) has a mounting body (32) that has at least two interconnected shaped parts (72, 74) made of flat material, and in that the mounting body (32) on the one hand forms a mounting region (62) molded into the shaped parts (72, 74) and on the other hand forms at least one stiffening region (64) arranged outside the mounting region (62) and molded into the shaped parts (72, 74).

2. A trailer hitch in accordance with embodiment 1, wherein, in the mounting region (62), at least one of the shaped parts (72, 74) forms at least one support surface (64) for the bearing unit (20).

3. A trailer hitch in accordance with embodiment 1 or 2, wherein the two shaped parts (72, 74) are arranged on mutually opposed sides of a center plane (76) of the mounting body (32) running transversely to the crossmember (34).

4. A trailer hitch in accordance with the preceding embodiments, wherein each of the shaped parts (72, 74) is formed in one piece.

5. A trailer hitch in accordance with the preceding embodiments, wherein each of the shaped parts (72, 74) has a contour profile that, on the corresponding side of a center plane (76) of the mounting body (32), has an extent between outer regions (70, 71) of the mounting body (32) but varies by reshaping of the flat material transversely to the areal extent of said material.

6. A trailer hitch in accordance with embodiment 5, wherein the mounting region (62) is molded into the contour profile of at least one of the shaped parts (72, 74).

7. A trailer hitch in accordance with embodiment 5 or 6, wherein the at least one stiffening region (66, 68) is molded in the contour profile of at least one of the shaped parts (72, 74).

8. A trailer hitch in accordance with the preceding embodiments, wherein an aperture (56) is provided in the mounting region (62) to partially receive the bearing unit (20) and penetrates both shaped parts (72, 74).

9. A trailer hitch in accordance with embodiment 8, wherein the support surface (64) in the respective shaped part (72, 74) is arranged outside the aperture (56).

10. A trailer hitch in accordance with embodiment 8 or 9, wherein the support surface (64) is arranged in the respective shaped part (72, 74) in a manner running around the aperture (56).

11. A trailer hitch in accordance with the preceding embodiments, wherein the aperture (56) has a shape deviating from a rotational symmetry with respect to a center axis (80) of the aperture.

12. A trailer hitch in accordance with embodiments 3 to 11, wherein the aperture (56) is configured to receive a portion (54) of the bearing unit (20).

13. A trailer hitch in accordance with the preceding embodiments, wherein the bearing unit (20) abuts with a support element (52) against the support surface (64).

14. A trailer hitch in accordance with the preceding embodiments, wherein the bearing unit (20) is supported on each of the shaped parts (72, 74).

15. A trailer hitch in accordance with the preceding embodiments, wherein the bearing unit (20) is supported at least on one, in particular on each, of the shaped parts (72, 74) in the region of the aperture (56).

16. A trailer hitch in accordance with the preceding embodiments, wherein the bearing unit (20) has a bearing body (50) which engages in the aperture (56).

17. A trailer hitch in accordance with embodiment 16, wherein the bearing body (50) is supported on one side of the mounting body (32) by a support body (52) and on an opposite side of the mounting body (32) by a holding element (226, 254).

18. A trailer hitch in accordance with embodiment 16 or 17, wherein the bearing body (50) has a bearing sleeve (54) which penetrates the aperture (56) and which, on a side opposite the support body (52), has a holding extension (222, 222′), which in particular protrudes beyond the aperture (56), has a holding receptacle (224, 234), and to which the holding element (226, 254) is fixable.

19. A trailer hitch in accordance with embodiment 18, wherein the holding element (226, 254) and the holding receptacle (224, 234) are configured so as to cooperate in such a way that the holding element (226, 254) is movable towards the support element (52) by a relative movement in relation to the holding receptacle (224, 234).

20. A trailer hitch in accordance with embodiments 8 to 19, wherein a plurality of fastening openings (172, 174) for connection elements (170) for mounting of the bearing unit (20), said openings penetrating both shaped parts (72, 74), are provided in the mounting region (62), in particular around the aperture (56) and at a spacing therefrom.

21. A trailer hitch in accordance with the preceding embodiments, wherein the bearing unit (20) is configured as a pivot bearing unit, on which the ball neck (10) is mounted pivotably about a pivot axis (22).

22. A trailer hitch in accordance with embodiment 21, wherein the mounting body (32) and in particular also the center plane (76) of the mounting body (32) extends perpendicularly to the pivot axis (22).

23. A trailer hitch in accordance with embodiment 21 or 22, wherein the pivot bearing unit (20) penetrates the aperture (56) and on one side of the aperture (56) supports the ball neck (10) pivotably and on the other side of the aperture (56) has a drive unit (60) for locking the ball neck (10) in the working position (A) and/or the rest position (R) and/or for performing the pivoting movement.

24. A trailer hitch in accordance with the preceding embodiments, wherein the shaped parts (72, 74) are fixedly connected to one another in the at least one stiffening region (66).

25. A trailer hitch in accordance with the preceding embodiments, wherein the mounting body (32) has a stiffening region (66) on both sides of the mounting region (62).

26. A trailer hitch in accordance with the preceding embodiments, wherein the stiffening regions (66, 68) extend as far as the outer regions of the mounting body (32).

27. A trailer hitch in accordance with the preceding embodiments, wherein the stiffening regions (66) run along outer regions (70, 71) of the mounting body (32).

28. A trailer hitch in accordance with the preceding embodiments, wherein the mounting body (32) has, in the corresponding stiffening region (66) relative to the mounting region (62), a bulge running away from a center plane (76) of the mounting body (32), formed by at least one of the shaped parts (72, 74), in particular by both shaped parts (72, 74).

29. A trailer hitch in accordance with the preceding embodiments, wherein at least one of the shaped parts (72, 74) in the at least one stiffening region (66) has molded-in beads or bent edges (86, 88, 96, 98).

30. A trailer hitch in accordance with the preceding embodiments, wherein the bulge of the mounting body (32) is formed by the beads or bent edges (86, 88, 96, 98), running away from one another, of at least one or both of the shaped parts (72, 74).

31. A trailer hitch in accordance with the preceding embodiments, wherein at least one shaped part, in particular both shaped parts in the respective stiffening region (66, 68) have, in cross section, at least one, in particular a plurality of stepped embossings (86, 88, 92, 94, 96, 98, 102, 104) of the flat material.

32. A trailer hitch in accordance with the preceding embodiments, wherein at least one of the stepped embossings (86, 88, 92, 94, 96, 98, 102, 104) of the flat material is formed in a manner running around the mounting region (62).

33. A trailer hitch in accordance with the preceding embodiments, wherein at least one of the stepped embossings of the flat material extends in the vicinity of an outer region (70, 71) of the mounting body (32).

34. A trailer hitch in accordance with the preceding embodiments, wherein the shaped parts (72, 74) have connection segments (112, 114, 116, 118 152) lying against one another in at least one stiffening region (66, 68).

35. A trailer hitch in accordance with the preceding embodiments, wherein the shaped parts (72, 74) are connected to one another in the region of the connection segments (112, 114, 152) with a substance-to-substance bond.

36. A trailer hitch in accordance with embodiment 34 or 35, wherein the shaped parts (72, 74) are connected to one another in the region of the connection segments (112, 114) with positive engagement.

37. A trailer hitch in accordance with the preceding embodiments, wherein, to form each stiffening region (66), the flat material of at least one of the shaped parts (72, 74) runs in the corresponding stiffening region (66) at least in some regions at a greater spacing from the other of the shaped parts (72, 74) than in the mounting region (62).

38. A trailer hitch in accordance with the preceding embodiments, wherein the shaped parts (72, 74) in the at least one stiffening region (66) have at least one reshaping (86, 88, 96, 98, 102, 104), by means of which the flat material of the shaped parts (72, 74) runs in the stiffening region (66) in some regions at a greater spacing from one another than in the mounting region (62).

39. A trailer hitch in accordance with the preceding embodiments, wherein the shaped parts (72, 74) in the stiffening region (64) have reshapings (86, 88, 96, 98) which cause the flat material of at least one of the shaped parts (72, 74) to be increasingly distanced from the flat material of the other of the shaped parts (72, 74) at least in some regions.

40. A trailer hitch in accordance with the preceding embodiments, wherein the shaped parts (72, 74) have, on a side opposite the crossmember (34), at least one connection segment (152) by means of which the shaped parts (72, 74) are fixedly connected to one another.

41. A trailer hitch in accordance with the preceding embodiments, wherein the mounting body (32) has, on a side lying between stiffening regions (66), holding flanges (144, 146) for connection to the crossmember (34) of the trailer hitch.

42. A trailer hitch in accordance with the preceding embodiments, wherein the shaped parts (72, 74) in the mounting region (62) are arranged at a spacing relative to one another.

43. A trailer hitch in accordance with embodiment 42, wherein the shaped parts (72, 74) are held, in the mounting regions (62), running at a spacing from one another by support elements (182) acting between the shaped parts.

44. A trailer hitch in accordance with embodiment 43, wherein, in the mounting regions (62), the support elements (182) are arranged in a gap between the shaped parts (72, 74) and support the shaped parts (72, 74) relative to one another.

45. A trailer hitch in accordance with embodiment 43 or 44, wherein the support elements (182) are individual bodies which extend from one shaped part (72, 74) to the other.

46. A trailer hitch in accordance with one of embodiments 43 to 45, wherein the support elements (182) are plate-like elements (184) which are formed from flat material and are arranged one above the other.

47. A trailer hitch in accordance with one of embodiments 43 to 46, wherein the support elements (182) are formed as annular bodies running in a closed manner around the aperture (56).

48. A trailer hitch in accordance with one of embodiments 43 to 47, wherein the support elements (182) have a cut-out that is congruent with the aperture (56).

Further features and advantages are the subject of the following description and also the depiction of some exemplary embodiments in the drawings.

### BRIEF DESCRIPTION OF THE DRAWINGS

FIG. 1 shows a rear view of a motor vehicle with a trailer hitch according to the present invention;

FIG. 2 shows a perspective illustration of the trailer hitch according to the invention with a view of the rear face of the motor vehicle in the direction of travel without showing the vehicle body or the bumper;

FIG. 3 shows a plan view of the trailer hitch according to the invention from above in the direction of the arrow A in FIG. 2;

FIG. 4 shows a perspective illustration of the trailer hitch according to the invention viewed in the direction of the pivot axis according to arrow B in FIG. 3;

FIG. 5 shows a section along line 5-5 in FIG. 3;

FIG. 6 shows a perspective view of a first exemplary embodiment of a mounting body according to the invention viewed in the direction of the arrow C in FIG. 3;

FIG. 7 shows a perspective illustration of the mounting body according to the invention viewed in the direction of the arrow D in FIG. 3;

FIG. 8 shows a view of the mounting body according to the invention in the direction of the arrow E in FIG. 6;

FIG. 9 shows a view of the mounting body according to the invention in the direction of the arrow F in FIG. 6;

FIG. 10 shows a horizontal section for example along line 10-10 of FIG. 9 through a second exemplary embodiment of the mounting body of a trailer hitch according to the invention;

FIG. 11 shows a horizontal section similar to FIG. 10 through a third exemplary embodiment of the mounting body of a trailer hitch according to the invention;

FIG. 12 shows a horizontal section similar to FIG. 10 through a fourth exemplary embodiment of the mounting body according to the invention on the basis of the second exemplary embodiment of the mounting body of a trailer hitch according to the invention;

FIG. 13 shows a horizontal section similar to FIG. 11 through a fifth exemplary embodiment of the mounting body on the basis of the third exemplary embodiment of the mounting body of a trailer hitch according to the invention;

FIG. 14 shows a plan view of the shaped parts for forming a sixth exemplary embodiment of the mounting body of a trailer hitch according to the invention;

FIG. 15 shows a section similar to FIG. 5 through a seventh exemplary embodiment of a trailer hitch according to the invention;

FIG. 16 shows a perspective illustration of a holding element of the seventh exemplary embodiment;

FIG. 17 shows a section similar to FIG. 5 through an eighth exemplary embodiment of a trailer hitch according to the invention; and

FIG. 18 shows a perspective illustration of a holding element of the eighth exemplary embodiment.

### DETAILED DESCRIPTION OF THE INVENTION

A first exemplary embodiment of a trailer hitch AK according to the invention for a motor vehicle comprises a ball neck, denoted as a whole by 10, which is held by a first end 12 on a pivot bearing body 14 and at a second end 16 carries a hitch ball which is denoted as a whole by 18 and to which a hitch ball receptacle of a trailer is fixable.

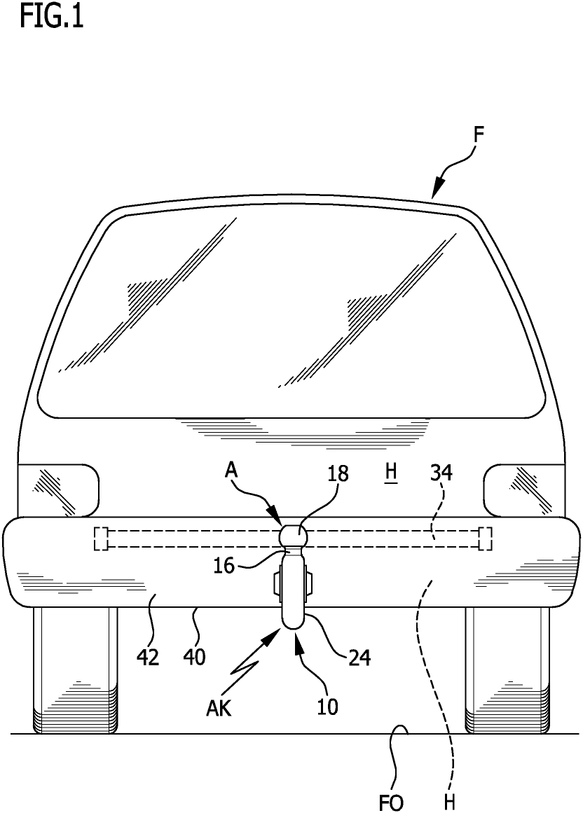

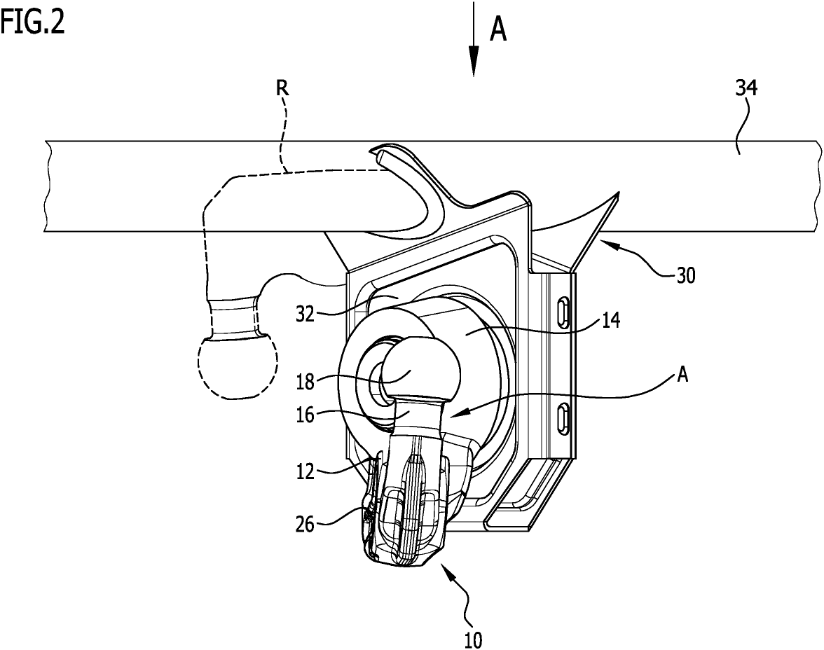

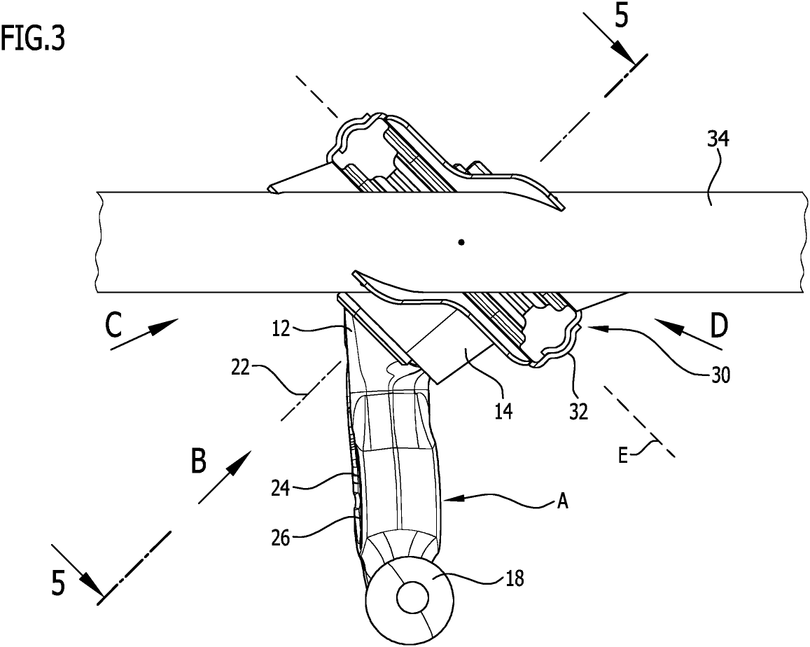

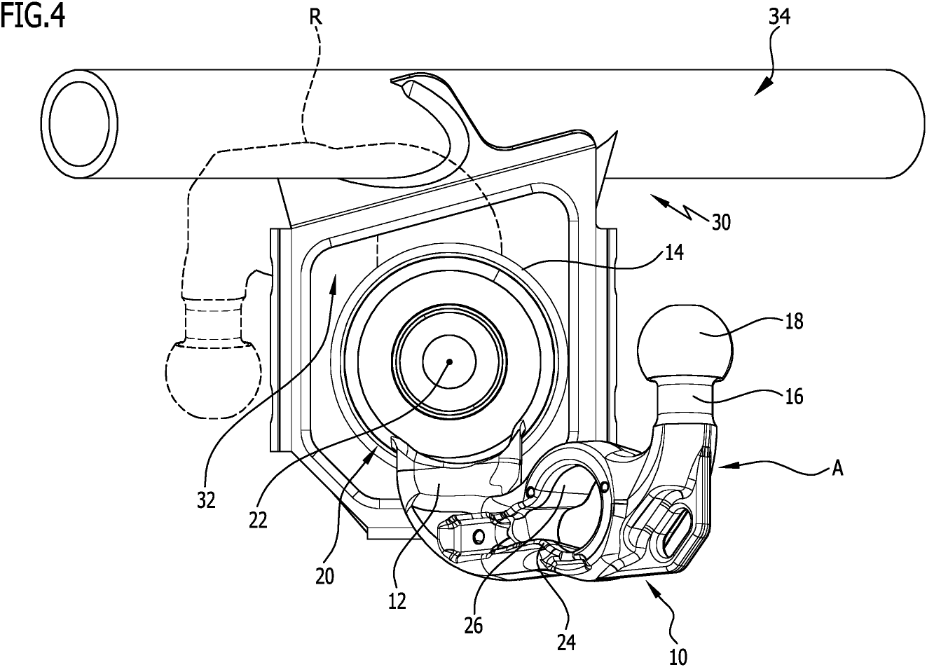

The ball neck 10 is illustrated here in FIGS. 1 to 4 by solid lines in a working position A and in FIGS. 2 and 4 by dashed lines in a rest position R.

The pivot bearing body 14 is mounted pivotably about a pivot axis 22 relative to a holding base 30, which is fixed to the vehicle, by a pivot bearing unit denoted as a whole by 20 (FIG. 4), wherein the holding base 30 preferably has a mounting body 32 which holds the pivot bearing unit 20, extends for example approximately parallel to a plane E perpendicular to the pivot axis 22 and additionally has a crossmember 34 which is fixed to the vehicle and which is fastenable in a known manner to a tail region H of a vehicle body F, specifically such that the pivot bearing unit 20 and the holding base 30 lie on a side of a lower edge 40 of a bumper unit 42 facing away from the road surface FO and are covered by the bumper unit 42 (FIG. 1).

In the working position A shown in FIGS. 1 to 4, the ball neck 10 engages, from below, with the lower edge 40 of the rear bumper unit 42 by a portion 24 adjoining the first end 12, so that the second end 16 and the hitch ball 18 together with a socket receptacle 26 are arranged on a side of the rear bumper unit 42 facing away from the vehicle body FK, whereas in the rest position R both the pivot bearing unit 20 and the entire ball neck 10 together with the hitch ball 18 are hidden from sight from the rear by the rear bumper unit 42.

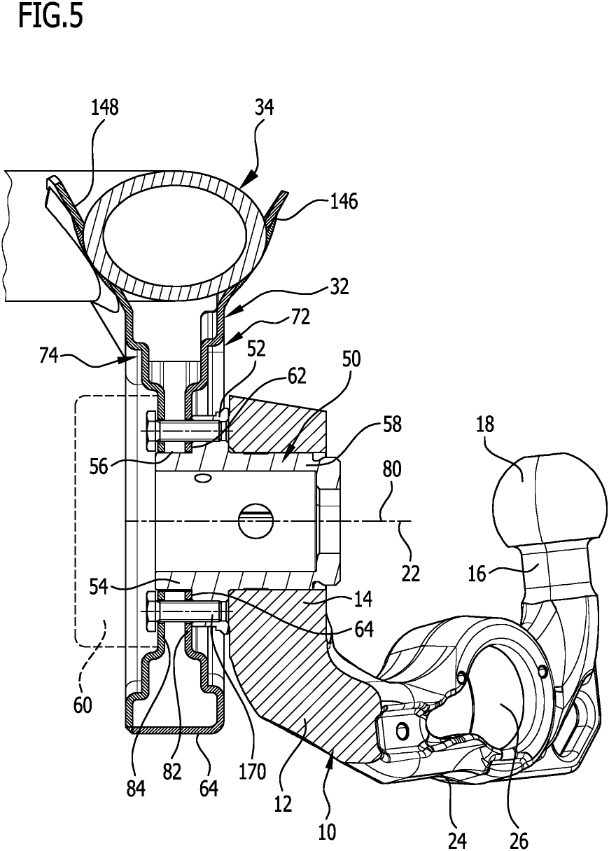

As shown in FIG. 5, the pivot bearing unit 20 comprises a bearing body 50, which has a flange 52 fixedly connectable to the mounting body 32 and which has a bearing sleeve 54 extending starting from the flange 52 and extending into an aperture 56 formed in the mounting body 32 or possibly through said aperture.

Furthermore, the bearing body 50 on its side of the flange 52 facing away from the mounting body 32 forms a support for the pivot bearing body 18, for example in the form of a guide sleeve 58, which engages around the pivot bearing body 14 and by means of which the pivot bearing body 14 is guided pivotably around the pivot axis 22.

Furthermore, a drive unit 60 of the pivot bearing unit 20 is preferably arranged on a side of the mounting body 32 opposite the guide sleeve 58 and for example is likewise held on the bearing body 50 and/or the mounting body 32.

The drive unit 60 is for example provided to drive a locking of the pivot bearing body 14 in the working position and the rest position and in particular can also be used to drive the pivoting movement about the pivot axis 22.

The flange 52 of the bearing body 50 is preferably supported here on a support surface 64 of a mounting region 62 of the mounting body 32, wherein the mounting body 32 is provided around the mounting region 62 with a plurality of stiffening regions 66, 68, improving the dimensional rigidity of the mounting body 32.

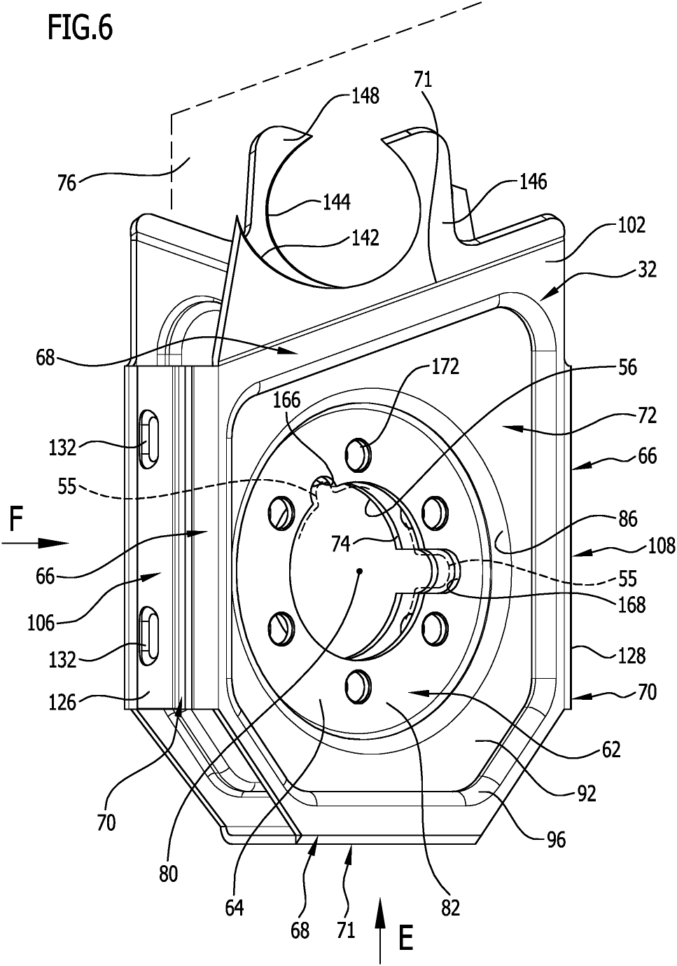

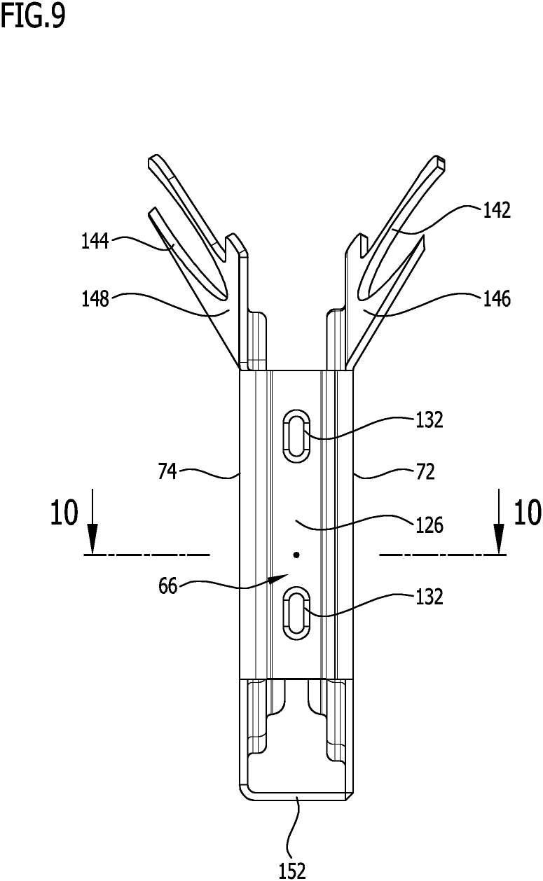

In the first exemplary embodiment shown in FIGS. 6 to 9, the mounting body 32 is formed by two shaped parts 72, 74 which extend between outer regions 70, 71 of the mounting body 32 in a contour profile which varies with the production of the shaped parts 72, 74 by reshaping of a flat material transversely to its areal extent.

The mounting region 62, which in particular is arranged centrally, as well as stiffening regions 66 between the mounting region and the outer regions 70 running towards the road surface FO and also stiffening regions 68 running transversely to the stiffening regions 66 are thus formed in the mounting body 32, one of said stiffening regions lying between the mounting region 62 and the outer region 71 facing the road surface FO.

This contour profile with the mounting region 62 and the stiffening regions 66, 68 comprises, specifically, one or more of the partial regions of the mounting body 32 explained hereinafter with reference to the first exemplary embodiment and created by reshapings.

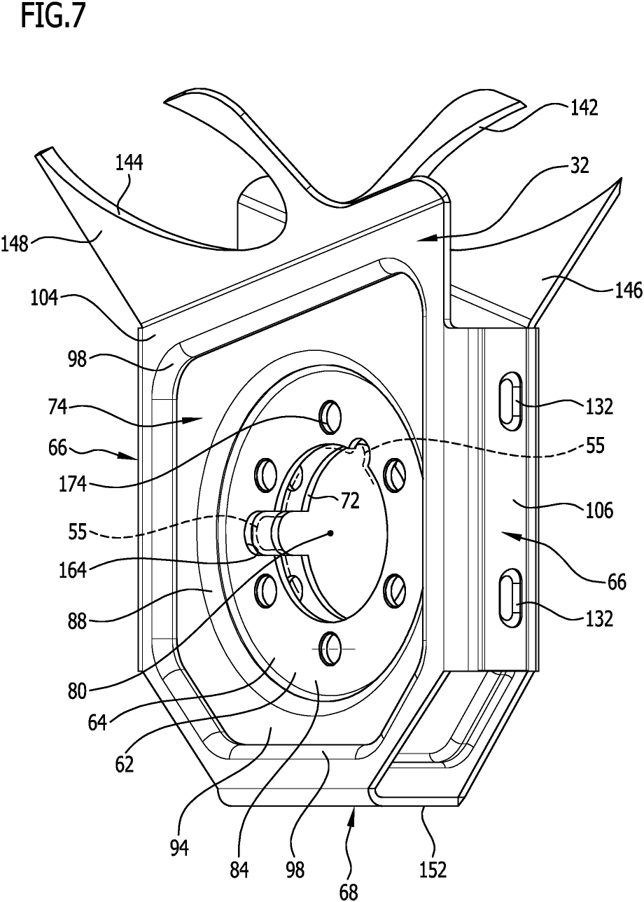

As illustrated for example in FIGS. 6 and 7 in a first exemplary embodiment of the mounting body 32 according to the invention, the shaped parts 72, 74 extend with their contour profile on opposite sides of a center plane 76, which runs perpendicularly to a center axis 80 of the aperture 56 running coaxially to the pivot axis 22, and starting from the aperture 56 of the mounting body 32 have a central region 82, 84, which runs around and surrounds the aperture and forms the mounting region 62.

Around this central region 82, 84, each of the shaped parts 72, 74 has an annular raised edge 86, 88 which extends away from the center plane 76, runs preferably in a closed manner, in particular annularly, around the aperture 56, moreover therearound at a spacing therefrom, and is adjoined by a flat intermediate region 92, 94, which likewise extends starting from the raised edge 86, 88 radially to the center axis 80 of the aperture 56 and in turn transitions into an outer raised edge 96, 98, which likewise runs in a closed manner around the intermediate raised edge 86, but for example does not run circularly around the center axis 80, but instead for example in the form of a polygon.

The outer raised edge 96, 98 is part of an outer stabilizing region 102, 104 of the respective shaped part 72, 74 and for example, as shown in FIGS. 6 to 9, comprises an outer flat region 103, 105 adjoining the outer raised edge 96, 98.

For connection of the shaped parts 72, 74 to one another, the stabilizing regions 102, 104 form outer overlap regions 106 and 108, in which connection segments 112 and 114 of the shaped part 72 and also 116 and 118 of the shaped part 74, said connection segments being bent over on mutually opposed sides in the direction of the center plane 76, overlap with one another and are connected to one another.

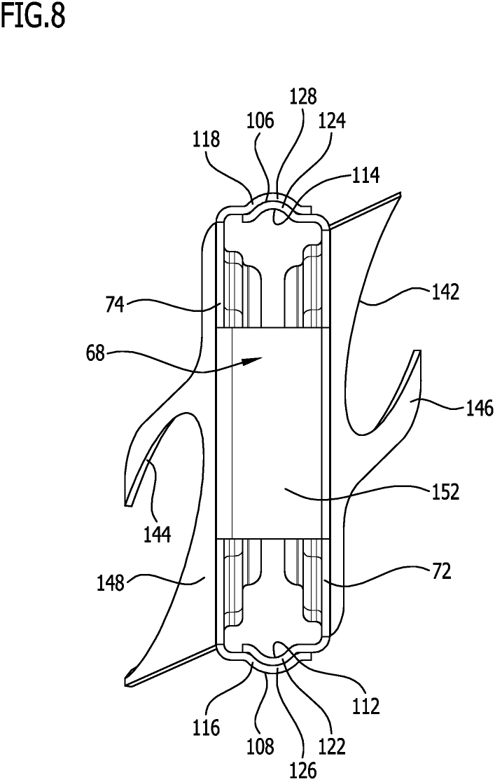

The connection segments 112 and 114 preferably each have beads 122 and 124 which are overlapped by beads 126 and 128 of the connection segments 116 and 118, wherein the beads 126 and 128 abut with positive engagement against the beads 122 and 124 (FIG. 8).

As shown in FIGS. 6 and 7, the weld openings 132 are still provided in each of the beads 126 and 128 and allow these weld openings 132 to be welded at the edge to the underlying beads 122 and 124 respectively, so that the connection segments 112 and 114 of one shaped part 72 are connected to the connection segments 116 and 118 of the other shaped part 74 not only with positive engagement by means of the beads 122 and 124 or 126 and 128, but additionally also are connected to one another in the bead openings 132 with a substance-to-substance bond in the region of the beads 122 and 124 and also 126 and 128.

Receptacles 142 and 144 for the crossmember 34 which are provided additionally on the shaped parts 72, 74 preferably lie between the overlap regions 106 and 108, wherein in FIGS. 6 and 7 the receptacles 142 and 144 are configured for a crossmember 34 that is round in cross section.

It is also conceivable, however, to adapt the receptacles 142 and 144 to any cross-sectional shapes of the crossmember 34.

The receptacles 142 and 144 preferably lie here in holding flanges 146 and 148 that run starting from the stabilizing regions 102, 104 and between the overlap regions 106 and 108.

Furthermore, the shaped parts 72 and 74 of the mounting body 32, on their side opposite the holding flanges 146 and 148, are also connected to one another by a connection segment 152 running likewise between the stabilizing regions 102 and 104, wherein the connection segment 152 can be molded for example on one of the shaped parts 72, 74 and can be bent over starting from the shaped part.

The connection segment 152, however, can also be formed by an edge segment of each of the shaped parts 72, 74, said edge segment being bent over in the direction of the center plane 76, wherein in this case the partial regions of the connection segment 152 formed by the various shaped parts 72, 74 are each welded to one another.

Due to the multiple raised edges 86 and 88 and also 96 and 98 forming the stiffening regions 66, 68 transitioning into one another and also due to the outer stabilizing regions 102 and 104, each of the shaped parts 72, 74 has a bulge running around the relevant mounting region 62 and running away from the center plane 76, whereby each of the shaped parts 72, 74 itself has an improved rigidity.

The rigidity of the shaped parts 72, 74 is also additionally significantly improved by the connection thereof in the overlap regions 106 and 108 by means of the connection segments 112 to 118 and also the connection segment 152 and the holding flanges connected to the crossmember 34.

With this structural solution of the mounting body 32 from the at least two stiffening regions 66, 68 created in the described way by shaping of the shaped parts 72, 74 and the connections between the shaped parts 72, 74, a high overall rigidity of the mounting body 32 is achieved, although the latter is composed merely of two shaped parts 72, 74 formed from flat material, for example produced by reshaping and/or stamping.

For connection of the flange 52 of the bearing body 50 to the central region 82 or 84 to which the flange 52 is applied, mutually opposed fastening openings 172 and 174 are provided around the opening 56 at equal angular spacings in the relevant flat side 82, 84 and serve to receive connection elements 170, in the simplest case screws, so that the flange 52 of the respective bearing body is fixable on the mounting body 32 by connection elements, for example screws, penetrating the relevant mounting region 62.

In addition, the aperture 56 is preferably not circular, but has a deviation from a circular shape running around the center axis 80, for example by cut-outs 166, 168 extending starting from a circular shape radially to the center axis 80, so that the bearing body 50 can extend into these cut-outs 166 and 168 by positive-locking protrusions 55 (shown in a dashed manner in FIGS. 6 and 7) molded on the bearing sleeve 54, and thus is fixed non-rotatably in the aperture 56 of the mounting body 32.

The mounting regions 62 of the central regions 82, 84 are indeed provided with a high level of dimensional rigidity already by the shaping of the shaped parts 72, 74 and their additional connections, however, the mounting of the flange 52 by connection elements penetrating the fastening openings 172, 174 results in high compressive forces on the central regions 82, 84, and therefore it is expedient to support the central regions 82, 84 of the molded parts 72, 74 relative to one another.

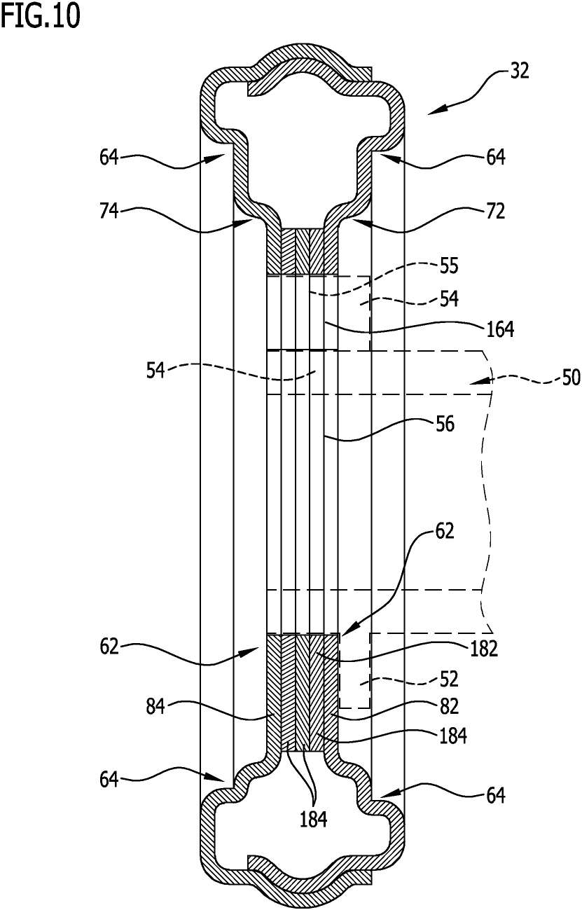

To this end, for example, as shown in FIG. 10, it is provided in a second exemplary embodiment to also provide, between the central regions 82, 84, support for these regions relative to one another, for example by one or more support elements 182, against which the shaped parts 72, 74 abut with their central regions 82, 84.

In the simplest case the support elements 182 can likewise be insert parts 184 formed from shaped flat material, more specifically such that a plurality of the insert parts 184, lying one on top of the other, serve to support the central regions 82, 84.

In FIG. 10 the bearing body 30 is additionally shown in a dashed manner, wherein positive-locking protrusions 55 molded on the bearing sleeve 54 and engaging in the cut-outs 168 are shown.

Alternatively, in a third exemplary embodiment it is provided to use individual or connected support bodies 186 as support element 182 in the region of the fastening openings 172, 174 for each set of mutually opposed fastening openings 172 and 174, the support bodies supporting the central regions 82 and 84 relative to one another.

The support bodies 186 can be annular bodies or blocks here, for example, the apertures of which are arranged congruently to the corresponding fastening openings 172, 174.

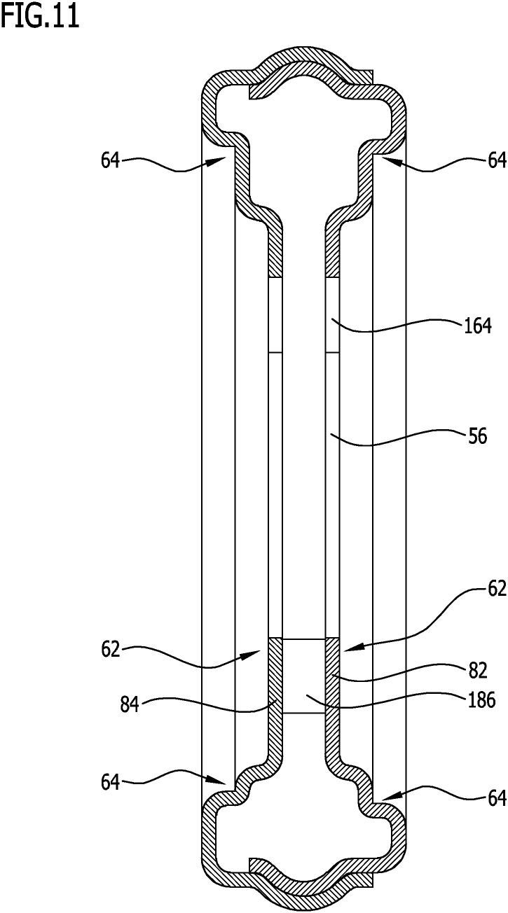

The support elements 182, for example in the form of the insert parts 184 or the support bodies 186, can be connected to the shaped parts 72, 74 for example by substance-to-substance bonding, as shown in FIGS. 10 and 11.

A substance-to-substance bonding of this kind could be, for example, an adhesive bonding or a welding, in particular welding at specific spots or over areas.

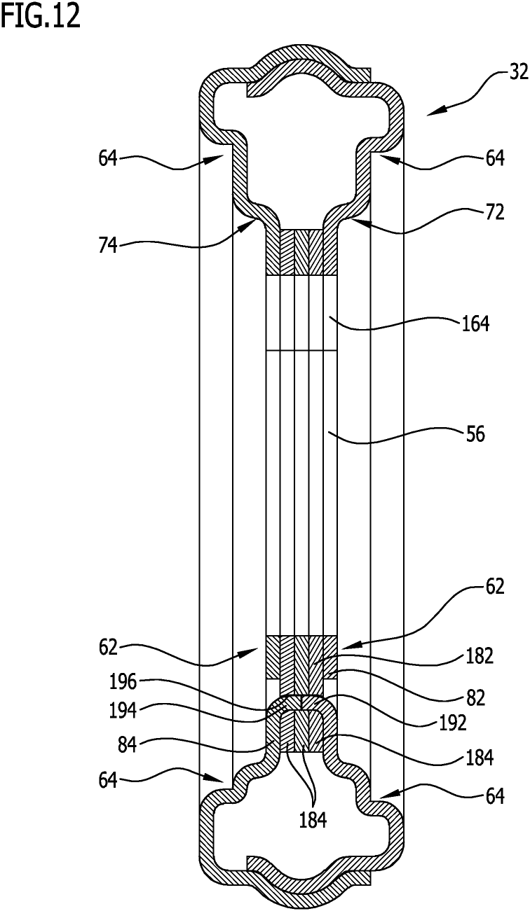

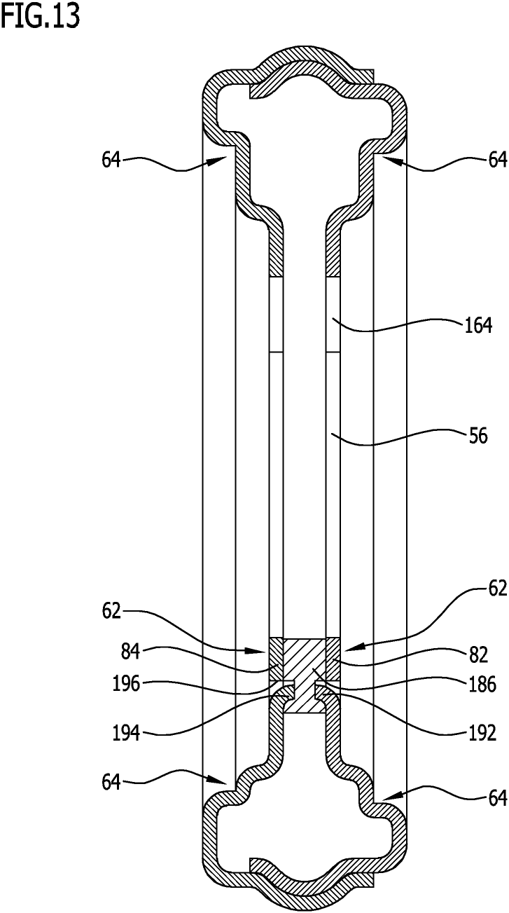

In a fourth or fifth embodiment, however, it is also possible, in particular when assembling the shaped parts 72, 74 together with the support elements 182 to form the mounting body 32, to fix the insert parts 184 or the support bodies 186, as shown in FIG. 12 or FIG. 13, by holding fingers 192 and 194 produced from the shaped parts 72, 74, in particular in the central regions 82, 84, by being bent out, the holding fingers engaging in corresponding recesses 196 of the insert parts 184 or the support bodies 186.

These holding fingers 192, 194 can serve here as a preliminary positioning means for the support elements 182 when connecting the shaped parts 72, 74, wherein for example a substance-to-substance bond to the shaped parts 72, 74 is also produced, or also for final positioning, since an application of force to the shaped parts 72, 74 in the central regions 82, 84 is provided by the connection elements 170 for fixing the bearing body 50, said force being sufficient to provide supplementary force-locking fixing of the support elements 182.

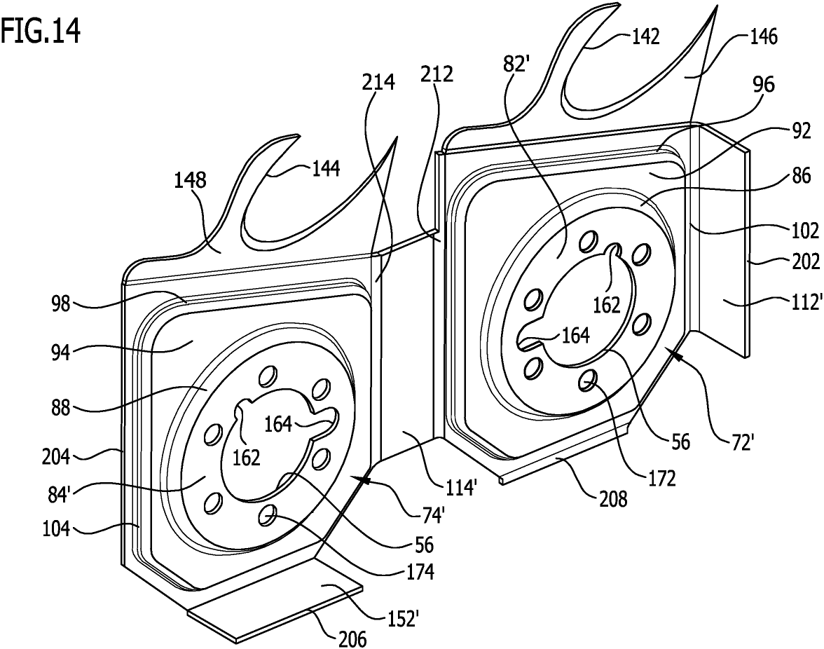

In a sixth advantageous exemplary embodiment, shown in FIG. 14, it is provided that, to produce the mounting body 32′, the shaped parts 72′ and 74′ are produced from a continuous piece of flat material by reshaping and trimming, so that, instead of the outer overlap regions 106 and 108 of the first exemplary embodiment, only one connection element 112′ and 114′ is provided in each case, wherein the connection element 114′ is molded on the two shaped parts 72′, 74′ and the connection segment 112′ is molded on one side to the shaped part 72′ and with its free edge region 202 is connectable to an edge region 204 of the shaped part 74′ opposite the connection element 114′, for example by welding.

Similarly, the connection segment 152′ has a free edge region 206 which faces away from the shaped part 74′ and which is likewise connectable to an edge region 208 of the shaped part 72′, for example by welding.

The shaped parts 72′, 74′ produced initially from the flat material are bent over at bending edges 212 and 214 provided on either side of the connection segment 114′ and connecting the latter to the shaped parts 72′ and 74′ respectively, so that the shaped parts 72′ and 74′ are arranged facing one another with their central regions 82′ and 84′ and for example run substantially parallel to one another, wherein in this state the connection between the edge regions 202 and 204 and the edge regions 206 and 208 can then be produced by welding.

In addition, the shaped parts 72′ and 74′ are formed similarly to the above-described shaped parts 72 and 74 of the first and second exemplary embodiment, and therefore, in respect of their configuration, in particular their contour profile, reference can be made fully to the above description thereof provided within the scope of the exemplary embodiments.

Alternatively to the provision of connection elements 170 for fixing the bearing body 50 to the mounting body 32, the bearing body 50 can also be fixed without the fastening openings 162 and 164 and the connection elements 170.

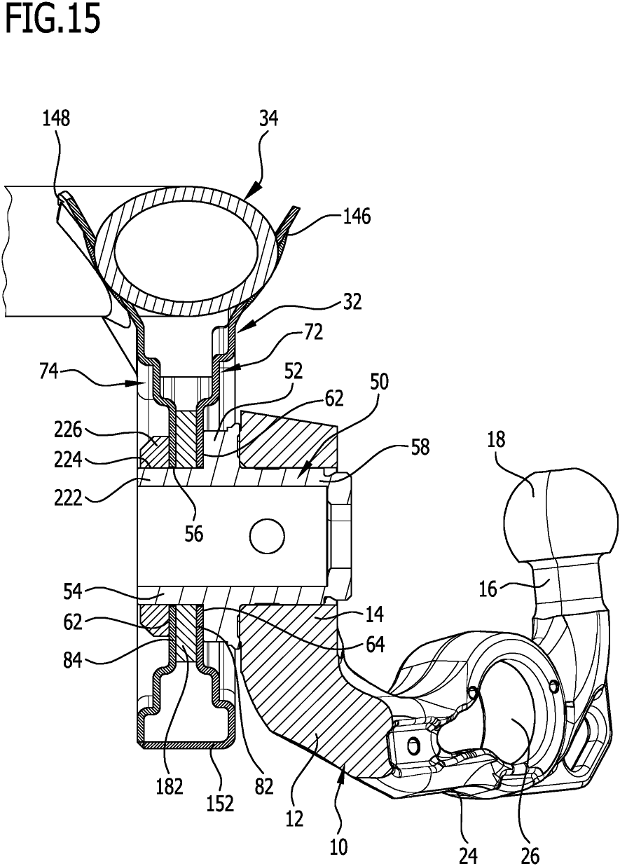

A seventh exemplary embodiment of a trailer hitch according to the invention, shown in FIG. 15, is based for example on a mounting body 32 according to the second or fourth exemplary embodiment, wherein in this case the bearing sleeve 54 extends through the aperture 56 and on a side opposite the flange 52 forms a holding extension 222, by means of which the bearing sleeve 54 protrudes beyond the mounting region 62 which is provided on the holding body 32 opposite the mounting region 62 that supports the flange 52 of the bearing body 50.

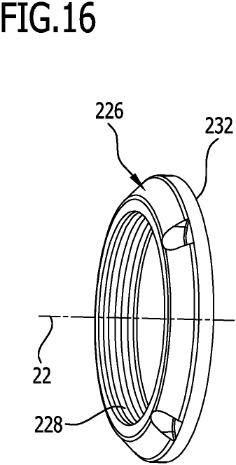

The holding extension 222 is provided with a holding receptacle 224 which for example is configured as an external thread of the holding extension 222, so that a holding ring 226 is fixable as holding element to the holding extension 222 and for example, as shown in FIG. 16, is provided with an internal thread 228, so that, by screwing the holding ring 226 onto the holding receptacle 224, the holding ring can be supported by an end face 232 against the mounting region 62 which is arranged on the mounting body 32 opposite the mounting region 62 supporting the flange 52.

The bearing body 50 is thus fixable relative to the mounting body 32 by the flange 52, which abuts on one side of the mounting body 32 in the mounting region 62, and by the holding ring 226, which abuts with the end face 232 against the opposite mounting region 62, wherein in particular in this case the mounting regions 62 are supported relative to one another by the support elements 182 and thus ensure a stable fixing of the bearing body 50 also under large forces acting thereon.

Alternatively to the provision of the receptacle 224 configured as an external thread and the internal thread 228 of the holding ring 226, it is also possible to provide other positive-locking elements forming a connection with positive engagement between the holding ring 226 and the holding extension 222, the positive-locking elements allowing the mounting body to be clamped between the flange 52 and the holding ring 226 by way of relative movement of the holding ring 226 in relation to the holding extension 222.

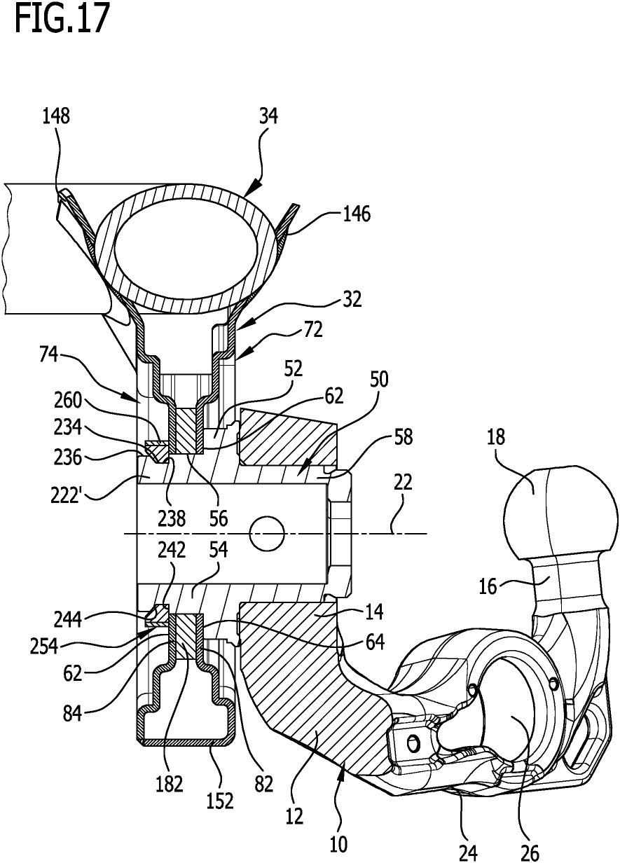

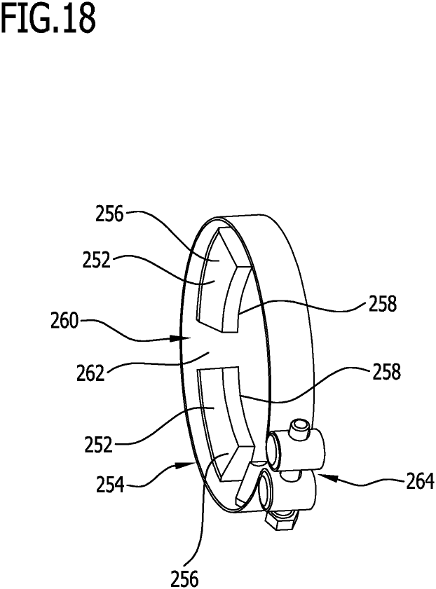

In an eighth exemplary embodiment of a trailer hitch according to the invention, shown in FIGS. 17 and 18, the holding extension 222′ comprises a groove 234, which extends starting from an outer contour 236 of the holding extension 222′ into the holding extension 222′, for example in the direction of the pivot axis 22, and runs as far as a groove bottom 238.

For example, the groove 234 has a groove wall 242 which faces the flange 52 and which is offset so far in the direction of the flange 252 that it lies between the mutually opposed mounting regions 62 of the mounting body 32 when the bearing body 50 is fixedly mounted on the mounting body 32.

Furthermore, a groove wall 244 opposite the groove wall 242 runs with increasing extent from the outer contour 236 in the direction of the groove bottom 238 and in the direction of the groove wall 242 and thus forms a wedge face, wherein in this embodiment of the groove 234 it narrows with increasing depth starting from the outer contour 236 of the holding extension 222.

As shown in FIG. 18, wedge bodies 252 of a holding ring 254 can be pressed as holding elements into this groove, wherein the wedge bodies 252 are formed as arc segments, and have wedge faces 256 which cooperate with the wedge-shaped groove wall 244 so that, as the wedge bodies 252 are pressed increasingly into the groove 234, the wedge bodies 252 can be applied with pressing faces 258 opposite the wedge faces 256 against the mounting region which is arranged opposite the mounting region 62 of the mounting body 32 supporting the flange 52.

To press the wedge bodies 252 into the groove 234, a clamping ring denoted as a whole by 260 is provided and surrounds the holding extension 222′ radially from the outside and has the wedge bodies 252 arranged on its inner side 262, wherein the clamping ring 260 is provided with a clamp lock 264, which on the one hand makes it possible for the clamping ring 260 to be opened to such an extent that the wedge bodies 252 can be brought into engagement with the groove 234 and then for the outer circumference of the clamping ring 260 to be made smaller and thus moved radially in the direction of the groove 234 so that the wedge bodies 252 are pressed into the groove 234 and, by the cooperation of the wedge faces 256 with the relevant groove wall 244, move in the direction of the mounting region 62 in order to clamp the mounting body 32 with the mutually opposed mounting regions 62 between the flange 52 and the wedge bodies 252 and thus fix the bearing body 50 on the mounting body 32.

In this exemplary embodiment, the support elements 182 are also provided here between the mounting regions 62 and support the mounting regions 62 of the mounting body 32 relative to one another.

1. A trailer hitch for motor vehicles, comprising a bearing unit which carries a ball neck which at a first end is connected to the bearing unit and at a second end carries a hitch ball, and a holding base which supports the bearing unit and which is connectable to a vehicle body, in particular by of a crossmember mountable on the vehicle body, wherein the holding base has a mounting body that has at least two interconnected shaped parts made of flat material, and wherein the mounting body on the one hand forms a mounting region molded into the shaped parts and on the other hand forms at least one stiffening region arranged outside the mounting region and molded into the shaped parts.

2. The trailer hitch in accordance with claim 1, wherein, in the mounting region, at least one of the shaped parts forms at least one support surface for the bearing unit.

3. The trailer hitch in accordance with claim 1, wherein the two shaped parts are arranged on mutually opposed sides of a center plane of the mounting body running transversely to the crossmember.

4. The trailer hitch in accordance with claim 1, wherein each of the shaped parts is formed in one piece.

5. The trailer hitch in accordance with claim 1, wherein each of the shaped parts has a contour profile that, on the corresponding side of a center plane of the mounting body, has an extent between outer regions of the mounting body but varies by reshaping of the flat material transversely to the areal extent of said material.

6. The trailer hitch in accordance with claim 5, wherein the mounting region is molded into the contour profile of at least one of the shaped parts.

7. The trailer hitch in accordance with claim 5, wherein the at least one stiffening region is molded in the contour profile of at least one of the shaped parts.

8. The trailer hitch in accordance with claim 1, wherein an aperture is provided in the mounting region to partially receive the bearing unit and penetrates both shaped parts.

9. The trailer hitch in accordance with claim 8, wherein the support surface in the respective shaped part is arranged outside the aperture.

10. The trailer hitch in accordance with claim 8, wherein the support surface in the respective shaped part is arranged running around the aperture.

11. The trailer hitch in accordance with claim 1, wherein the aperture has a shape deviating from a rotational symmetry with respect to a center axis of the aperture.

12. The trailer hitch in accordance with claim 3, wherein the aperture is configured to receive a portion of the bearing unit.

13. The trailer hitch in accordance with claim 1, wherein the bearing unit abuts with a support element against the support surface.

14. The trailer hitch in accordance with claim 1, wherein the bearing unit is supported on each of the shaped parts.

15. The trailer hitch in accordance with claim 1, wherein the bearing unit is supported at least on one, in particular on each, of the shaped parts in the region of the aperture.

16. The trailer hitch in accordance with claim 1, wherein the bearing unit has a bearing body which engages in the aperture.

17. The trailer hitch in accordance with claim 16, wherein the bearing body is supported on one side of the mounting body by a support body and on an opposite side of the mounting body by a holding element.

18. The trailer hitch in accordance with claim 16, wherein the bearing body has a bearing sleeve which penetrates the aperture and which, on a side opposite the support body, has a holding extension, which in particular protrudes beyond the aperture and has a holding receptacle, to which the holding element is fixable.

19. The trailer hitch in accordance with claim 18, wherein the holding element and the holding receptacle are configured so as to cooperate in such a way that the holding element is movable towards the support element by a relative movement in relation to the holding receptacle.

20. The trailer hitch in accordance with claim 8, wherein a plurality of fastening openings for connection elements for mounting of the bearing unit, said openings penetrating both shaped parts, are provided in the mounting region, in particular around the aperture and at a spacing therefrom.

21. The trailer hitch in accordance with claim 1, wherein the bearing unit is configured as a pivot bearing unit, on which the ball neck is mounted pivotably about a pivot axis.

22. The trailer hitch in accordance with claim 21, wherein the mounting body and in particular also the center plane of the mounting body extends perpendicularly to the pivot axis.

23. The trailer hitch in accordance with claim 21, wherein the pivot bearing unit penetrates the aperture and on one side of the aperture supports the ball neck pivotably and on the other side of the aperture has a drive unit for locking the ball neck in the working position and/or the rest position and/or for performing the pivoting movement.

24. The trailer hitch in accordance with claim 1, wherein the shaped parts are fixedly connected to one another in the at least one stiffening region.

25. The trailer hitch in accordance with claim 1, wherein the mounting body has a stiffening region on either side of the mounting region.

26. The trailer hitch in accordance with claim 1, wherein the stiffening regions extend as far as the outer regions of the mounting body.

27. The trailer hitch in accordance with claim 1, wherein the stiffening regions run along outer regions of the mounting body.

28. The trailer hitch in accordance with claim 1, wherein the mounting body has, in the corresponding stiffening region, relative to the mounting region, a bulge running away from a center plane of the mounting body, formed by at least one of the shaped parts, in particular by both shaped parts.

29. The trailer hitch in accordance with claim 1, wherein at least one of the shaped parts in the at least one stiffening region has molded-in beads or bent edges.

30. The trailer hitch in accordance with claim 1, wherein the bulge of the mounting body is formed by the beads or bent edges running away from one another, of at least one or both of the shaped parts.

31. The trailer hitch in accordance with claim 1, wherein at least one shaped part, in particular both shaped parts in the respective stiffening region have, in cross section, at least one, in particular a plurality of stepped embossings of the flat material.

32. The trailer hitch in accordance with claim 1, wherein at least one of the stepped embossings of the flat material is formed in a manner running around the mounting region.

33. The trailer hitch in accordance with claim 1, wherein at least one of the stepped embossings of the flat material extends in the vicinity of an outer region of the mounting body.

34. The trailer hitch in accordance with claim 1, wherein the shaped parts have connection segments lying against one another in at least one stiffening region.

35. The trailer hitch in accordance with claim 1, wherein the shaped parts are connected to one another in the region of the connection segments with a substance-to-substance bond.

36. The trailer hitch in accordance with claim 34, wherein the shaped parts are connected to one another in the region of the connection segments with positive engagement.

37. The trailer hitch in accordance with claim 1, wherein, to form each stiffening region, the flat material of at least one of the shaped parts runs in the corresponding stiffening region at least in some regions at a greater spacing from the other of the shaped parts than in the mounting region.

38. The trailer hitch in accordance with claim 1, wherein the shaped parts in the at least one stiffening region have at least one reshaping, by which the flat material of the shaped parts runs in the stiffening region in some regions at a greater spacing from one another than in the mounting region.

39. The trailer hitch in accordance with claim 1, wherein the shaped parts in the stiffening region have reshapings which cause the flat material of at least one of the shaped parts to be increasingly distanced from the flat material of the other of the shaped parts at least in some regions.

40. The trailer hitch in accordance with claim 1, wherein the shaped parts have, on a side opposite the cross member, at least one connection segment by which the shaped parts are fixedly connected to one another.

41. The trailer hitch in accordance with claim 1, wherein the mounting body has, on a side lying between stiffening regions, holding flanges for connection to the crossmember of the trailer hitch.

42. The trailer hitch in accordance with claim 1, wherein the shaped parts in the mounting region are arranged at a spacing relative to one another.

43. The trailer hitch in accordance with claim 42, wherein the shaped parts are held, in the mounting regions, running at a spacing from one another by support elements acting between the shaped parts.

44. The trailer hitch in accordance with claim 43, wherein, in the mounting regions, the support elements are arranged in a gap between the shaped parts and support the shaped parts relative to one another.

45. The trailer hitch in accordance with claim 43, wherein the support elements are individual bodies which extend from one shaped part to the other.

46. The trailer hitch in accordance with claim 43, wherein the support elements are plate-like elements which are formed from flat material and are arranged one above the other.

47. The trailer hitch in accordance with claim 43, wherein the support elements are formed as annular bodies running in a closed manner around the aperture.

48. The trailer hitch in accordance with claim 43, wherein the support elements have a cut-out that is congruent with the aperture.
